(19) United States
(12) Patent Application Publication
(10) Pub. No.: US 2008/0192327 A1
(43) Pub. Date: Aug. 14, 2008

(54) METHOD AND SYSTEM FOR SPECKLE REDUCTION USING AN ACTIVE DEVICE

(76) Inventor: Nayef M. Abu-Ageel, Haverhill, MA (US)

Correspondence Address: MICHAEL K. LINDSEY;GAVRILOVICH, DODD & LINDSEY, LLP, 3303 N. SHOWDOWN PL., TUCSON, AZ, 85749, US

(21) Appl. No.: 11/966,791

(22) Filed: Dec. 28, 2007

Related U.S. Application Data
(60) Provisional application No. 60/882,666, filed on Dec. 29, 2006.

(51) Int. Cl. G02B 26/00

(52) U.S. Cl. 359/237

(57) ABSTRACT

A system and method for reducing speckle of a laser beam is disclosed. The system includes at least an active device capable of temporally and/or spatially averaging the speckle pattern of a laser. The device can be used with an external diffuser or have an integrated diffusive layer within its structure to enhance the speckle reduction. The speckle reduction system alters the phase and/or path of light rays within an input laser beam as they pass through a transmissive device or reflect off of the surface of a reflective device.

This application claims the benefit of U.S. Provisional Application No. 60/882,666 filed on Dec. 29, 2006, which is incorporated herein by reference.

### TECHNICAL FIELD

The present invention relates generally to laser systems, and more particularly, to a method and system for reducing laser speckle.

### BACKGROUND

Due to their many advantages which include high brightness as well as their spectral and angular beam characteristics, lasers are considered attractive light sources for various applications such as projection displays, microscopy, microlithography, machine vision and printing. However, one drawback to using lasers in these systems is speckle. Basically, speckle is an undesirable variation in the cross-sectional intensity of a laser beam. In laser projection systems, it usually makes images appear grainy and less sharp. Speckle is due to interference patterns that result from the high degree of temporal and spatial coherence of light emitted by most lasers. When such coherent light is reflected from a rough surface or propagates through a medium with random refractive index variations, speckle shows up as an uneven, random distribution of light intensity. This uneven brightness degrades the quality and usefulness of laser illumination systems.

The prior art describes various techniques for speckle reduction. For example, in U.S. Pat. No. 5,224,200 to Rasmussen et al. propose a speckle reduction apparatus 100, as illustrated in FIG. 1A. The system consists of a coherence delay line in series between a laser and a homogenizer 28. The coherence line consists of a totally reflecting mirror 24 and a partially reflecting mirror 22 separated by a distance 25 equal to an integer multiple of half the coherence length of the original laser beam. The laser beam 20 strikes the partially reflecting mirror 22 first, which transmits part of the beam and reflects the remainder toward the totally reflecting mirror 24 where it is reflected back toward the partially reflecting mirror 22. This process continues until the reflected beam bypasses the partially reflecting mirror 22. This final beam and the series of beams transmitted through the partially reflecting mirror 22 are focused by a lens 26 into a homogenizer 28. Beams entering the homogenizer 28 are offset by multiples of their coherence length, leading to a reduction in their apparent coherence length, which in turn, reduces the amount of speckle.

Another speckle reduction system 110 is discussed in U.S. Patent Application Publication No. 2006/0012842 to Abu-Ageel, which is hereby incorporated by reference. As shown in FIG. 1B, speckle reduction system 110 utilizes a light guide 45, a highly reflective mirror 43 at the input face of the light guide 45 and a partially reflective mirror 46 at the exit face of the light guide 45. The coherent laser beam 40 is introduced to diverging lens 42 then light pipe 45 through a clear aperture 41 in the highly reflective mirror 43. Successive beamlets exit the light guide 45 through the partially reflective mirror 46 to provide output laser light with reduced speckle.

In U.S. Pat. No. 5,313,479 to J. M. Florence and U.S. Pat. No. 6,594,090 B2 to Kruschwitz et al., a moving diffuser is used to remove or reduce the speckle pattern. In U.S. Patent Application Publication No. 2006/0126184A1 to Kim et al., a vibrating mirror located between a beam-shaping unit and a micro-display (or between an optical fiber bundle and a beam-shaping unit) is used to remove or reduce the speckle pattern. In U.S. Patent Application Publication No. 2003/0030880A1 to Ramanujan et al., an electro-optic modulator is used to reduce the appearance of speckle.

In U.S. Pat. No. 6,897,992 B2 to H. Kikuchi, the laser beam is rotated and equally divided into its S and P polarization components. After separating the S and P polarization components, an optical path difference that is at least equal to the coherence length of the laser beam is generated between the S and P polarization components through appropriate delay means. The '992 Patent also discloses an intensity separation means for dividing the laser beam into two or more parallel beamlets and delaying the beamlets relative to each other by an optical path difference that is at least equal to the coherence length of the laser.

B. Dingel et al. in “Speckle-Free Image in a Laser-Diode Microscope by Using the Optical Feedback Effect,” Optics Letters, Vol. 18, No. 7, April 1993, pp 549-551, teach a method of removing laser speckle by broadening the spectral linewidth of a laser and generating an output beam having a multimode spectrum that changes with time. This result is obtained by feeding a moderate amount of the laser light back into the cavity of the laser through the use of mirror, beam splitter and multimode fiber.

Although known methods of speckle reduction are effective in some applications, they nevertheless suffer from one or more of the following disadvantages: high power consumption of moving or vibrating parts, low degree of compactness especially when laser coherence length is large, long integration time, excessive loss of light energy (i.e., inefficiency), and/or lack of control over the spatial distribution of light in terms of angle and intensity.

Therefore, there is a need for a simple, compact, light weight, low power, short-integration time, and efficient speckle reduction system that provides control over the spatial distribution of laser light in terms of intensity and angle over a certain target area, such as the active area of a display panel.

### SUMMARY

Disclosed herein are relatively compact, light weight, low power, short-integration time, efficient speckle reduction systems capable of producing an output light beam of selected cross-sectional area and cross-sectional spatial distribution, in terms of intensity and angle. The improved speckle reduction systems can efficiently couple light from laser sources (e.g., a single laser or laser array) having a variety of sizes and shapes to illumination targets of various shapes and sizes. Also disclosed herein are improved methods of laser speckle reduction.

Various aspects, features, embodiments and advantages of the systems and methods are described in the following figures and detailed description, or they will be or will become apparent to one with skill in the art upon examination of the following figures and detailed description. It is intended that all of these aspects, features, embodiments and advantages be included within this description, be within the scope of the invention, and be protected by the accompanying claims, which ultimately define the present invention.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1A-1B are cross-sectional views of a prior art speckle reduction systems.

FIG. 2A is a cross-sectional view of a speckle reduction system utilizing a transmissive device with beams fixed at both ends.

FIG. 2B is a top view of the system of FIG. 2A.

FIG. 2C is a cross-sectional view of a speckle reduction system utilizing a transmissive device with cantilever beams.

FIG. 2D is a top view of the system of FIG. 2C.

FIG. 3A is a cross-sectional view of a speckle reduction system utilizing a reflective device with beams fixed at both ends.

FIG. 3B is a top view of the system of FIG. 3A.

FIG. 4A is a cross-sectional view of a speckle reduction system utilizing a reflective device with a comb-drive actuator.

FIG. 4B is a top view of the system of FIG. 4A.

FIG. 5A is a cross-sectional view of a speckle reduction system utilizing a transmissive device with a comb-drive actuator.

FIG. 5B is a top view of the system of FIG. 5A.

FIG. 6A is a cross-sectional view of a speckle reduction system utilizing a variable focus lens.

FIG. 6B is a cross-sectional view of a speckle reduction system utilizing a variable focus lens with an integrated diffusive layer.

FIG. 6C is a cross-sectional view of a variable focus lens.

FIG. 6D is a cross-sectional view of a device with a deformable surface.

FIG. 7A is a cross-sectional view of a speckle reduction system utilizing a transmissive device with an external diffuser.

FIG. 7B is a cross-sectional view of a speckle reduction system utilizing a reflective device with an external diffuser.

FIG. 8A is a cross-sectional view of a speckle reduction system utilizing a transmissive device and an integrator.

FIG. 8B is a cross-sectional view of a speckle reduction system utilizing a reflective device and an integrator.

FIGS. 9A-9I are cross-sectional views of a fabrication process of transmissive and reflective devices.

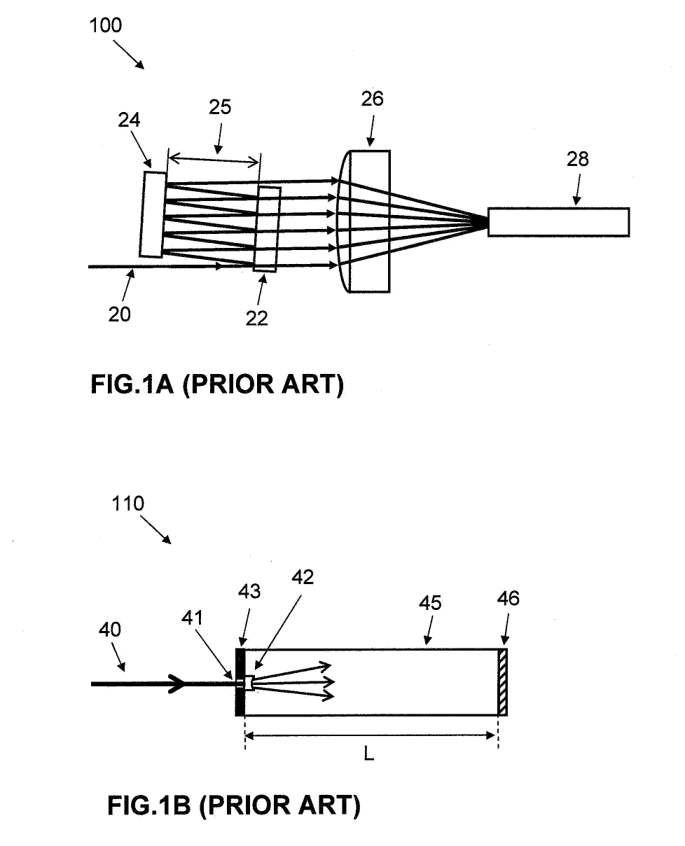

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

Disclosed herein are various exemplary embodiments of a laser speckle reduction system that incorporates at least an active device that can provide temporal and/or spatial averaging of speckle pattern. In operation, the speckle reduction system alters the phase and/or path of light rays within an input laser beam as they pass through a transmissive device or reflect off of the surface of a reflective device. The device is electrically, magnetically, piezo-electrically, electro-magnetically, or thermally actuated to spatially and/or temporally average the speckle pattern. The laser speckle reduction system is advantageous in that it is compact and consumes low power. The laser source may include a plurality of lasers that have different wavelengths and each laser may be a semiconductor, solid-state laser, or a gas laser.

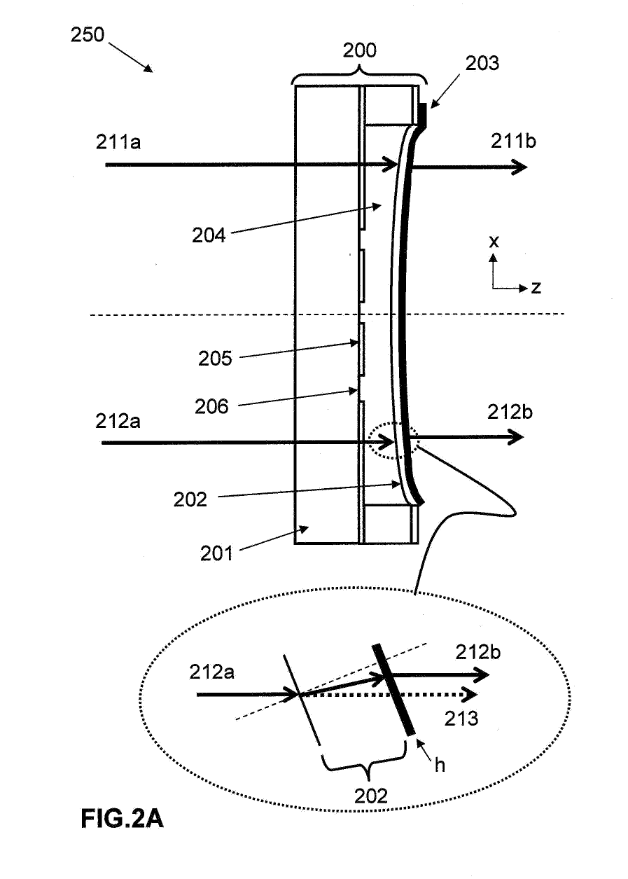

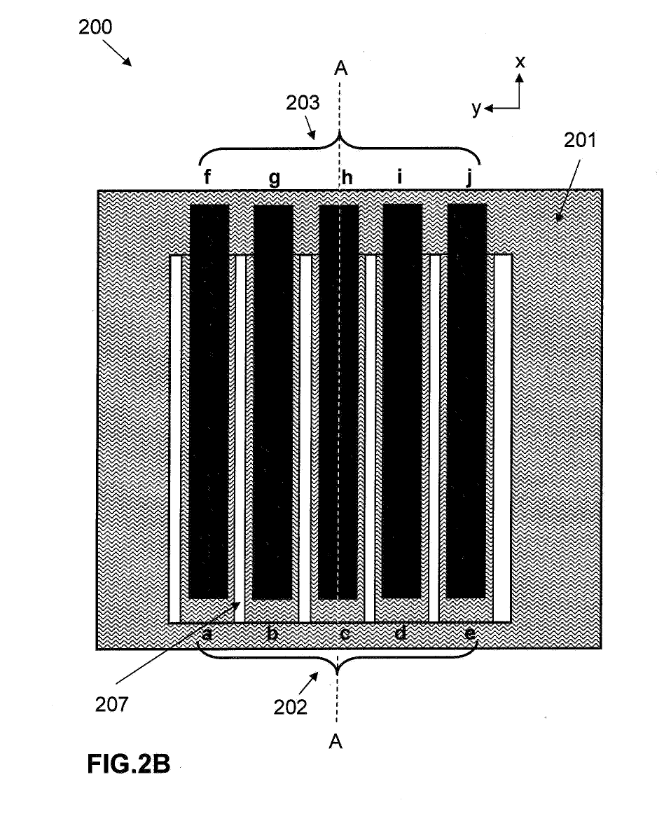

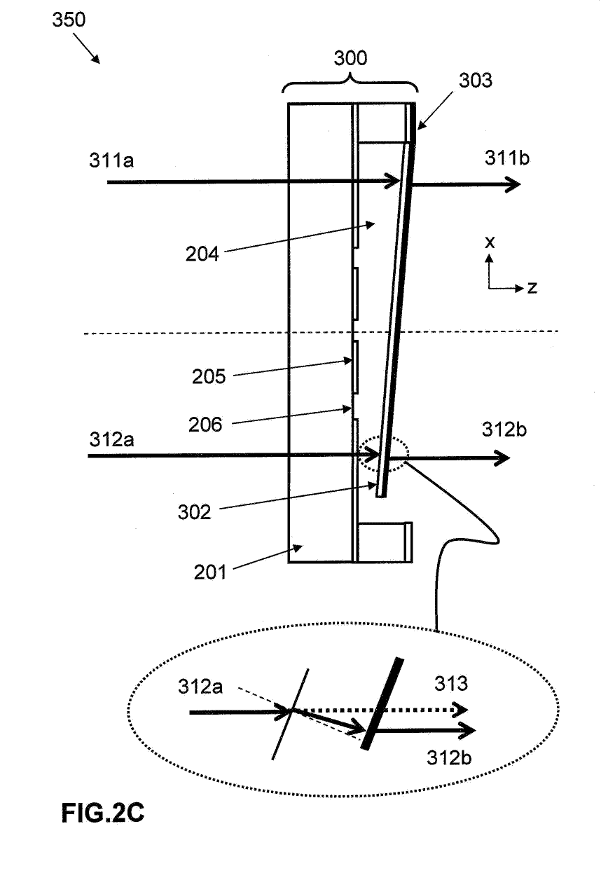

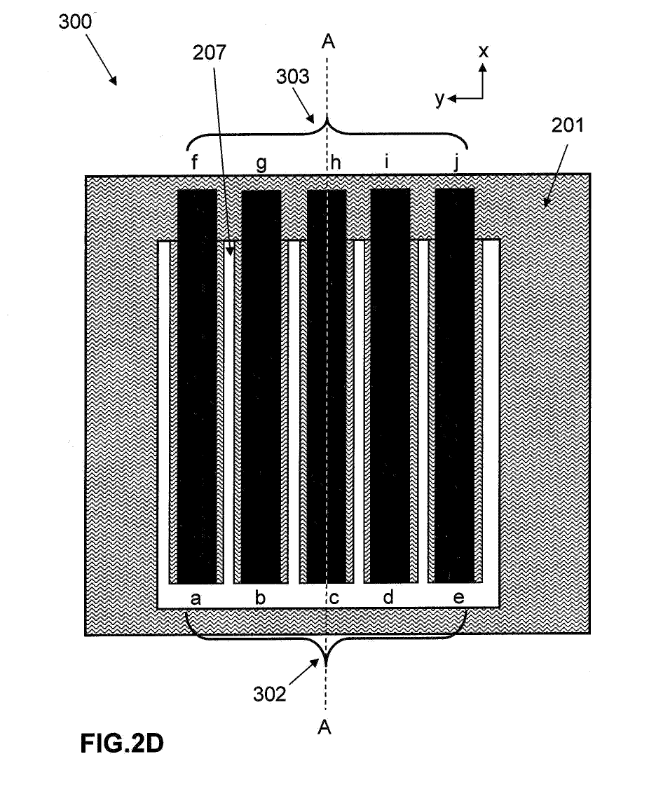

Turning now to the drawings, FIG. 2A shows a cross-sectional view (along line A of FIG. 2B) of a laser speckle reduction system 250 comprising a transmissive device 200. FIG. 2B shows a top view of transmissive device 200. Device 200 comprises a supporting substrate 201 with a deformable structure, e.g., an array 202 of deformable transmissive beams a, b, c, d and e with neighboring beams a, b, c, d and e being separated from each other by a lateral gap 207 (FIG. 2B) and array 202 being separated from the substrate by a vertical gap 204 (FIG. 2A). Examples of transmissive beam array 202 materials include SiOx and SiNx. The supporting substrate 201 has to be transparent at the selected wavelengths of the laser beam. Transparent substrates 201 may include glass, calcium fluoride, magnesium fluoride, lithium fluoride, barium fluoride, quartz and fused silica. For example, glass is a highly transparent material for the visible wavelengths. It is possible to use a non-transparent substrate (e.g. silicon) but a cavity within the supporting substrate 201 and below the deformable beam array 202 has to be made to allow the transmission of the light beam (e.g. rays 211a and 212a) through the substrate 201 without being blocked or substantially attenuated. The gap 207 between neighboring beams a, b, c, d and e can be reduced to zero resulting in a single intact structure or membrane. An array 203 of transparent top electrodes f, g, h, i and j is formed on the top surface of array 202. The top electrode array 203 can also be formed on the bottom surface of the beam array 202. The electrodes f, g, h, i and j of array 203 can be all connected together and driven by a single voltage source. A layer of transparent diffusive material can be deposited on top of the beam array 202 or the top electrode array 203 to provide random change in the phase of light passing through such layer. It is possible to etch a diffusive pattern in the beam array 202 using semiconductor etch techniques. A patterned bottom electrode 205 is formed on the top surface 206 of substrate 201. The bottom electrode 205 can be non-patterned or can have any selected pattern. If a zero voltage is applied between the top 203 and bottom 205 electrodes, the beam array 202 will stay parallel to the substrate surface 206. However, when a non-zero voltage is applied between electrodes 203 and 205, the beam array 202 is pulled down (FIG. 2A) by an electrostatic force. When a certain light ray (e.g. rays 211a and 212a) passes through the transmissive device 200, it experiences a varying degree of phase change and spatial movement as a function of time depending on device structure 200 as well as amplitude and frequency of the voltage applied between both electrodes 203 and 205. In addition, different rays within the light beam entering the device 200 experience different degrees of phase change and spatial movement with respect to each other depending on their respective positions within the device as well as the applied voltage. For example and as shown in the exploded view, ray 212a exits device 200 as ray 213 when a zero voltage is applied between top 203 and bottom 205 electrodes (i.e. the beam array 202 is parallel to the substrate surface 206). However, ray 212a exits device 200 as ray 212b when a non-zero voltage is applied between top 203 and bottom 205 electrodes. Light rays that pass through the lateral gap 207 between neighboring beams 202 experience no change in phase or spatial location.

FIG. 2C shows a cross-sectional view (along line A of FIG. 2D) of a laser speckle reduction system 350 comprising a transmissive device 300. Transmissive device 300 comprises a supporting substrate 201 with a deformable structure, e.g., an array 302 of deformable transmissive cantilever beams a, b, c, d and e that are separated from the substrate by a gap 204 (FIG. 2C) and neighboring cantilever beams a, b, c, d and e that are separated from each other by a lateral gap 207 (FIG. 2D). The lateral gap 207 between neighboring cantilever beams a, b, c, d and e can be reduced to zero resulting in a single cantilever structure. An array 303 of transparent top electrodes f, g, h, i and j is formed on the top surface of array 302. The electrodes f, g, h, i and j of array 303 can be all connected together and driven by a single voltage source. Examples of transparent electrode array 203 and 303 materials include thin metal and indium tin oxide (ITO) films. A layer of transparent diffusive material can be deposited on top of the beam array 302 or the top electrode array 303 to provide random change in the phase of light passing through such layer. It is possible to etch a diffusive pattern in the beam array 302 using semiconductor etch techniques. The operation of this device 300 is similar to that of device 200 except for the fact that device 300 provides substantially uniform phase change and uniform spatial movement at a certain point in time for all light rays (e.g. rays 311a and 312a) passing along the cantilever beam length (i.e. along the x-direction) as long as no diffusive structure is applied to the beam array 302.

In another embodiment, the beam array 302 of device 300 can be made of a combination of cantilever and fixed beams. The fixed beams are held to the substrate 201 at their both ends while the cantilever beams are held to the substrate 201 at one end and have a second free end.

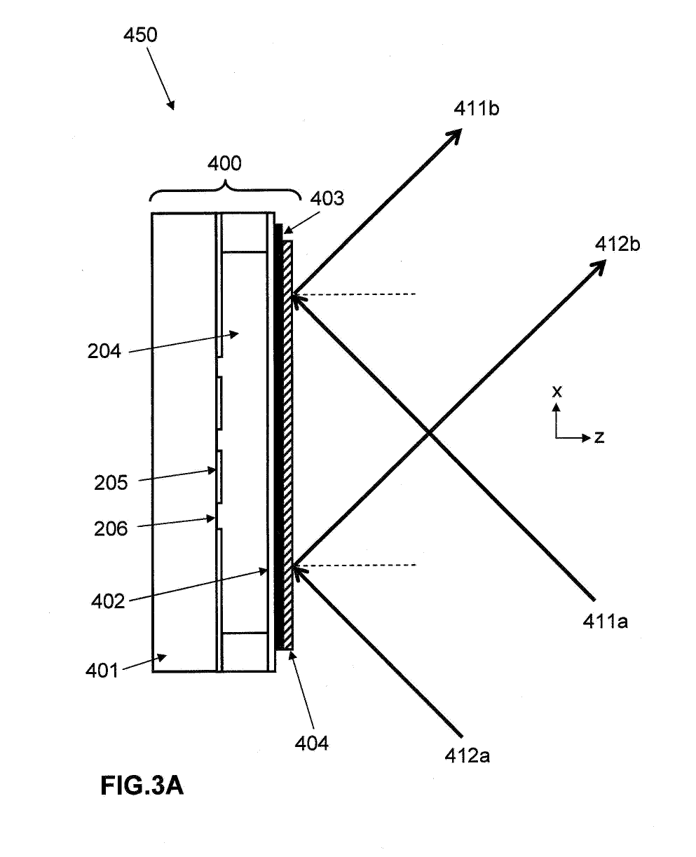

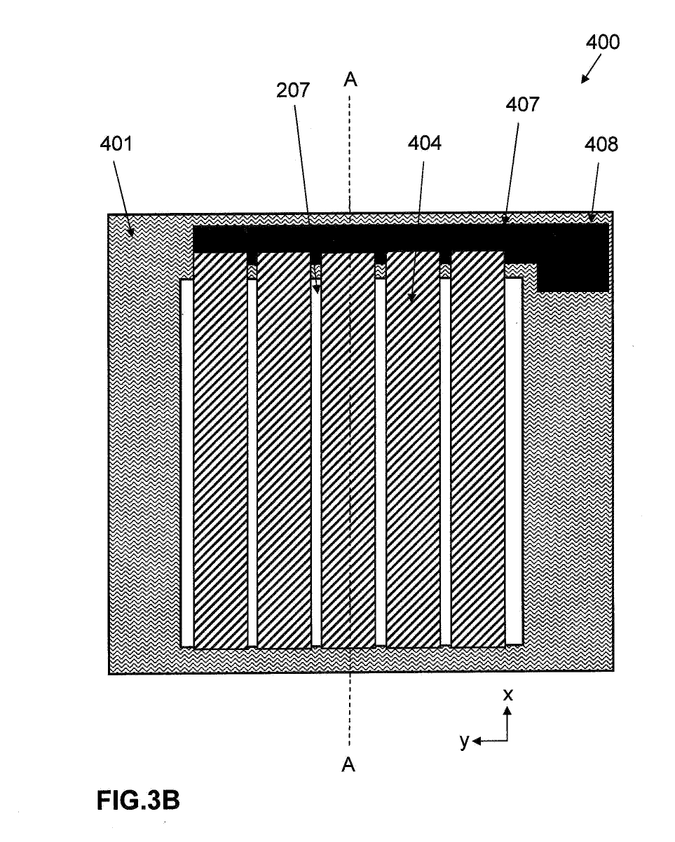

FIG. 3A shows a cross sectional view (along line A of FIG. 3B) of a laser speckle reduction system 450 comprising a reflective device 400. Reflective device 400 comprises a supporting substrate 401 with a deformable structure, e.g., an array 402 of deformable beams separated from the substrate by a gap 204 (FIG. 3A) and neighboring beams are separated from each other by a gap 207 (FIG. 3B). The supporting substrate 401 can be a non-transparent substrate (e.g. silicon substrate) without impacting the performance of the device. The cross sectional view (FIG. 3B) of device 400 shows a non-biased device. The lateral gap 207 between neighboring beams can be reduced to zero resulting in a single structure. An array 403 of top electrodes (non- transparent or transparent) is formed on the top surface of array 402. The top electrode array 403 can also be formed on the bottom surface of the beam array 402. The electrodes of array 403 can be all connected together and driven by a single voltage source through contact pad 408 as shown in FIG. 3B. A metal and/or dielectric mirror 404 is formed on the top surface of device 400 (on top of the electrode array 403 and/or the beam array 402 depending on the device structure). Alternatively, mirror 404 may comprise a reflective top electrode array 403 alone or combined with a dielectric mirror on top of reflective array 403. An optional layer of transparent diffusive material can be deposited on top of mirror 404. Alternatively, an optional diffusive structure can be etched in the mirror 404 using semiconductor etch techniques. A patterned bottom electrode 205 can be formed on the top surface 206 of the substrate 201. When a light beam impinges on device 400, it gets reflected and focused at a varying focal point depending on the applied voltage. However, this kind of focusing-lens operation is not necessary for speckle reduction. For example, the beams within the beam array 402 can be actuated separately to provide a random reflection for each ray (e.g. rays 411a and 412a) in terms of angle and focal point. Alternatively, the beam array 402 can be actuated collectively with a single voltage while using patterned top 403 and/or patterned bottom 205 electrodes to provide a random reflection for each ray in a light beam.

In another embodiment, the beam array 402 of reflective devices 400 can be made of cantilever beams (i.e. fixed at one end to the supporting substrate) or a combination of cantilever and fixed beams.

In another embodiment, reflective device 400 is utilized as a variable focus lens. In this device 400, the lateral gap 207 between neighboring beams is preferably reduced to zero resulting in a single deformable membrane.

The shapes of the transmissive and reflective devices 200, 300 and 400 are not limited to square shapes but can be circular, oval, rectangular or other shapes. The size of each beam within a beam array can be different from the size of other beams within the same array in terms of length, width and thickness.

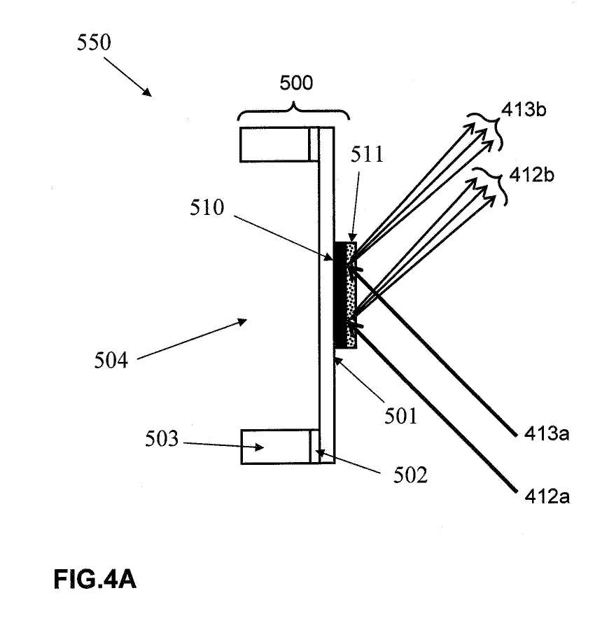

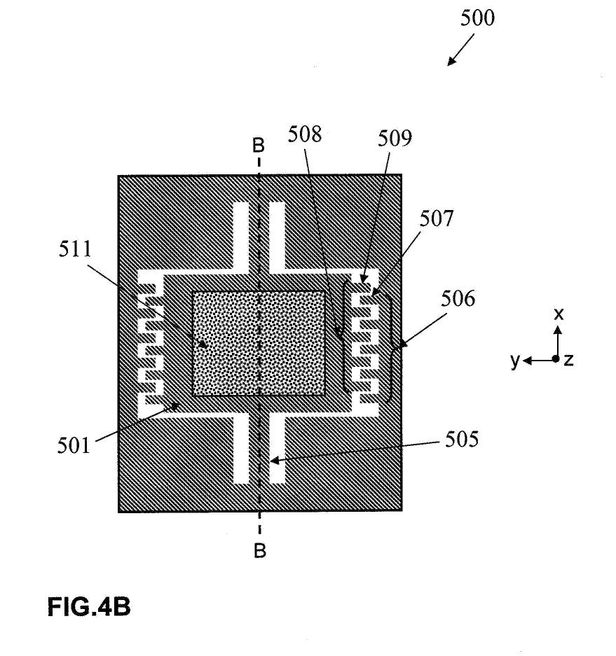

FIG. 4A shows a cross sectional view (along line B of FIG. 4B) of a laser speckle reduction system 550 comprising a mirror system 500. FIG. 4B shows a top view of FIG. 4A. A stationary comb-like structure 506 is attached to a substrate 503 as shown in FIG. 4B and contains stationary comb fingers 507 interdigitated with mobile comb fingers 509, which are part of a mobile comb-like structure 508. The mobile comb-like structure 508 is attached to a mobile element 501, which is in turn attached to the supporting substrate 503 (FIG. 4A) through flexures 505. Both mobile element 501 and mobile comb-like structure 508 are suspended over a cavity 504 by flexures 505. A cavity 504 is formed in the substrate 503 below and around element 501, mobile comb-like structure 508 and the flexures 505 in order to permit the movement of element 501, mobile comb-like structure 508, and flexures 505. This movement can be translational in the xy plane or rotational about the flexures 505 axis B. Frequency and amplitude of the bias voltage that vibrates element 501 are usually dependent on the application, for example, speckle reduction in lithography applications require vibrations at higher frequency than that required in display applications. A device with only translational movement (i.e. vibrating the mirror in the xy-plane) requires having an external diffuser receiving a light beam from the translational device, a diffusive layer on top of the mirror, or an etched diffusive layer as an integral part of the mirror 510 to spatially and temporally average the speckle pattern of the light beam that impinges on the mirror 510 surface. Mirror 510 can be deposited over the top surface of element 501 followed by the deposition of an optional diffusive layer 511 over the mirror 510 surface. Alternatively, diffusive layer 511 can be etched in the top surface of element 501 prior to the deposition of the mirror 510. It is also possible to etch a diffusive layer 511 in the mirror 510 top surface. Element 501, mirror 510 and diffusive layer 511 may have various shapes such as rectangular, square, round, and octagonal. The flexures 505 can have different shapes and sizes to enhance the performance of the mirror system for a given application. Flexures 505 can be, for example, torsion flexures, serpentine flexures, cantilever flexures, or one or more springs combined with pin-and-staple flexures. The diffusive layer 511 can be transmissive or reflective. The supporting substrate 503 is electrically isolated from element 501 by an insulating layer 502 such as SiOx layer. More details about the torsional type of mirror system 500 and other torsional mirror systems are discussed in U.S. Pat. Nos. 6,757,092 and 6,888,662 to Abu-Ageel. Each of the above patents is hereby incorporated by reference in its entirety for each of its teachings and embodiments. Translational and Vibratory actuators can be used to drive a mirror in the xy plane at a certain frequency. Translational actuators and systems are discussed in U.S. Patent Application Publication 2004/0033011 A1 to Chertkow and in U.S. Pat. No. 7,142,077 to Baeck et al., which are both hereby incorporated by reference. Vibratory structures are discussed in U.S. Pat. No. 5,747,690 to Park et al., which is hereby incorporated by reference. Actuation mechanisms can include electrical, electromagnetic, piezoelectric, magnetic, and thermal mechanisms. An electrostatic actuator that applies force directly on the flexure itself is disclosed in U.S. Pat. No. 6,201,629B1 issued to R. W. McClelland et al. This patent is hereby incorporated by reference in its entirety.

Kim et al. in U.S. Patent Application Publication No. 2006/0126184A1 proposed a speckle reduction system utilizing a vibrating mirror. Kim's proposed vibrating mirror is different from the vibrating mirror 400 and 500 of this disclosure in a fundamental aspect. Mirror 500 is an integrated device (i.e. mirror and actuator are made together as an integrated device using same fabrication process) while Kim's vibrating mirror utilizes an external piezoelectric actuator. This usually results in a mirror system 400 and 500 that usually consumes less power and has higher compactness. Therefore, vibrating mirror 400 and 500 of this disclosure can be used as an effective replacement for Kim's vibrating mirror in all embodiments disclosed in U.S. Patent Application Publication No. 2006/0126184A1, which is hereby incorporated by reference in its entirety.

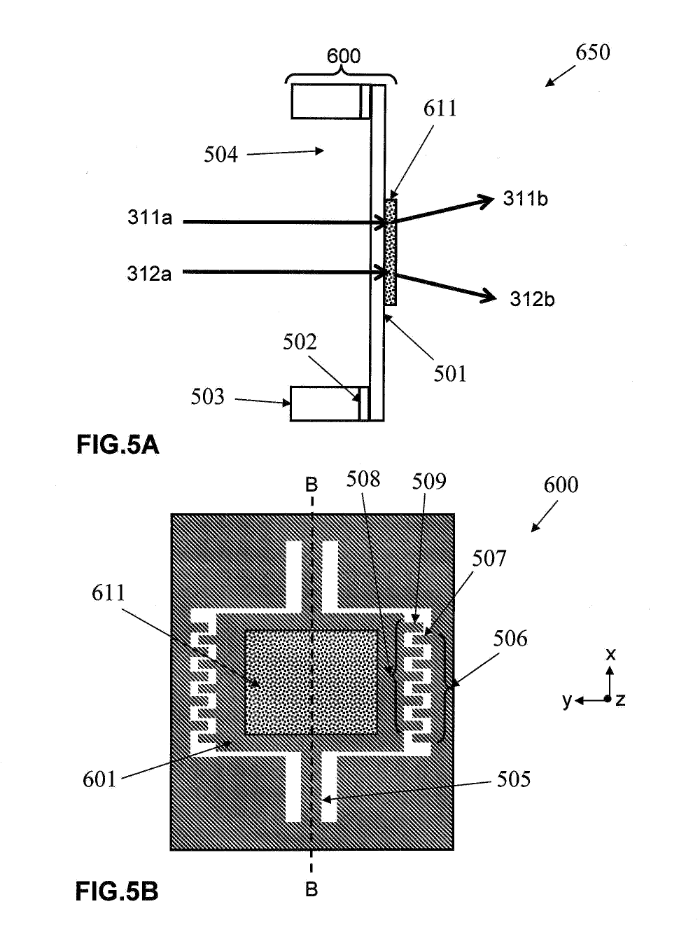

FIG. 5A shows a cross sectional view (along line B of FIG. 5B) of a laser speckle reduction system 650 comprising a transmissive device 600. FIG. 5B shows a top view of FIG. 5A. Transmissive torsional or translational device 600 is the same as that of FIGS. 4A-4B except for the removal of mirror layer 510, the use of a transmissive (rather than reflective) diffusive layer 611, and the use of a transmissive (rather than reflective) element 501. Transmissive torsional or translational device 600 can be used to alter the phase of a light beam as a function of time. When a torsional element is used in system 650, the use of an external diffuser or a diffusive layer 611 becomes optional.

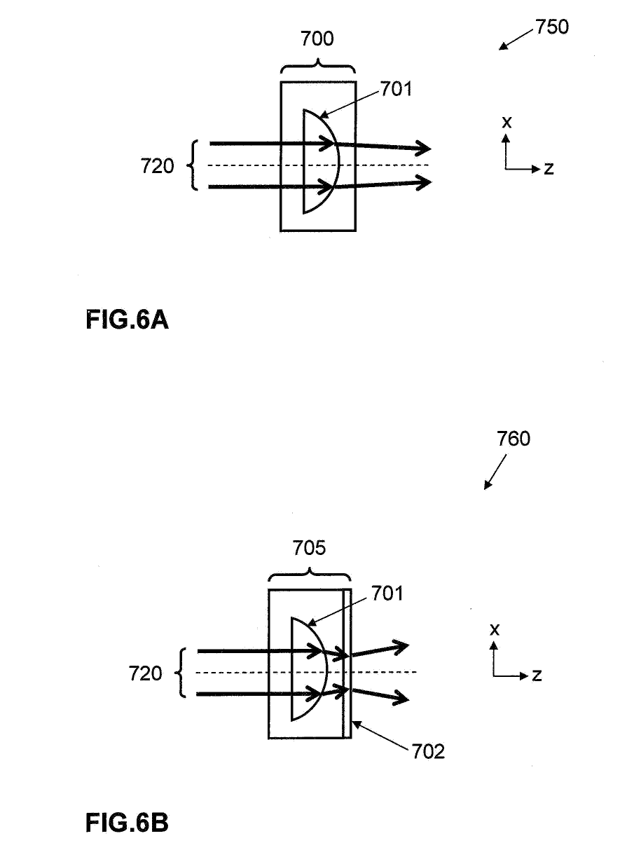

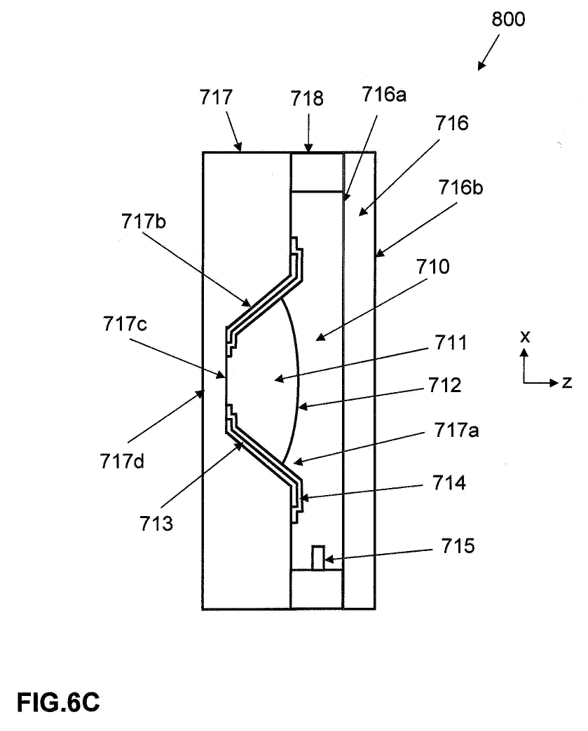

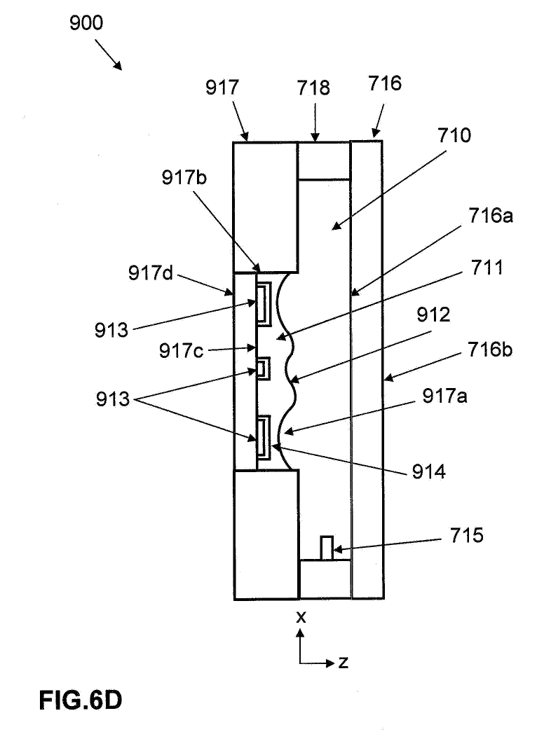

FIG. 6A shows a cross-sectional view of a speckle reduction device 750 utilizing a variable focus lens 700 with a deformable surface 701 and a laser beam 720. One example of a variable focus lens is discussed in US Patent Application Publication No. 2006/0152814A1 to Peseux, which is incorporated herein by reference in its entirety. Commercially-available variable focus lenses such as the ones provided by Varioptic S. A. can be used to reduce the speckle according to the current embodiment.

In another embodiment and as shown in FIG. 6B, speckle reduction device 760 has a diffusive layer 702 as an integral part of the variable focus lens 705 structure. The diffusive layer 702 allows more change in the phase of the laser beam 720 as it passes through it leading to enhanced temporal and/or spatial averaging of the speckle pattern.

A variable focus lens 800 as proposed in US Patent Application Publication No. 2006/0152814A1 is shown in FIG. 6C. Lens 800 comprises a cell having an upper transparent plate 716, side walls 718, and lower transparent plate 717 with a recess 717a that contains a drop of an oily insulating and transparent liquid 711. The remainder of the cell contains an electrically conductive aqueous and transparent liquid 710. The recess 717a has a tapered surface 717b, which is coated with a first electrode 713 made of an electrically conductive layer such as gold. The first electrode 713 is coated with an insulating layer 714. The interface surface 712 between the insulating 711 and conductive 710 liquids forms a deformable refractive surface. A second electrode 715 is in electrical contact with the conductive liquid 710. The curvature of the interface surface 712 can be changed by applying a voltage between electrodes 713 and 715. When a light beam passes through the lens 800, it gets focused at a certain focal point depending on the applied voltage. If the lens is biased with a voltage at a high enough frequency, the speckle pattern will be reduced through temporal and spatial averaging.

In another embodiment, a speckle reduction device utilizes a variable focus lens 800 with a diffusive layer applied to at least one surface 716a, 716b, 717c and 717d of the upper 716 or lower 717 plate surfaces. Light passing through the interface surface 712 will experience further change in its phase as it passes through the applied diffusive layer leading to further reduction in speckle.

In another embodiment and as shown in FIG. 6D, a speckle reduction device utilizes a deformable structure 900 that has a deformable surface 912 with a non-regular shape. This deformable structure 900 introduces temporal and spatial phase change to the laser beam that passes through it but does not necessarily focus the laser beam. Deformable structure 900 comprises a cell having an upper transparent plate 716, side walls 718, and lower transparent plate 917 with a recess 917a that contains a drop of an oily insulating and transparent liquid 711. The remainder of the cell contains an electrically conductive aqueous and transparent liquid 710. The recess 917a has a vertical surface 917b. A first electrode 913 made of an electrically conductive and transparent layer such as indium tin oxide (TIN) is deposited as a patterned layer on the bottom surface 917c of the recess 917a. The first electrode 913 is coated with an insulating layer 914. The interface surface 912 between the insulating 711 and conductive 710 liquids forms a deformable refractive surface. A second electrode 715 is in electrical contact with the conductive liquid 710. The shape of the interface surface 912 can be changed by applying a voltage between electrodes 913 and 715. When a light beam passes through the interface 912, its phase will change temporally and spatially depending on the applied voltage. If the deformable structure 900 is biased with a voltage at a high enough frequency, the speckle pattern will be reduced through temporal and spatial averaging.

In another embodiment, deformable structure 900 has a diffusive layer applied to at least one surface 716a, 716b, 917c and 917d of its upper 716 or lower 917 plates to further alter the phase of the laser beam that passes through the deformable surface 912.

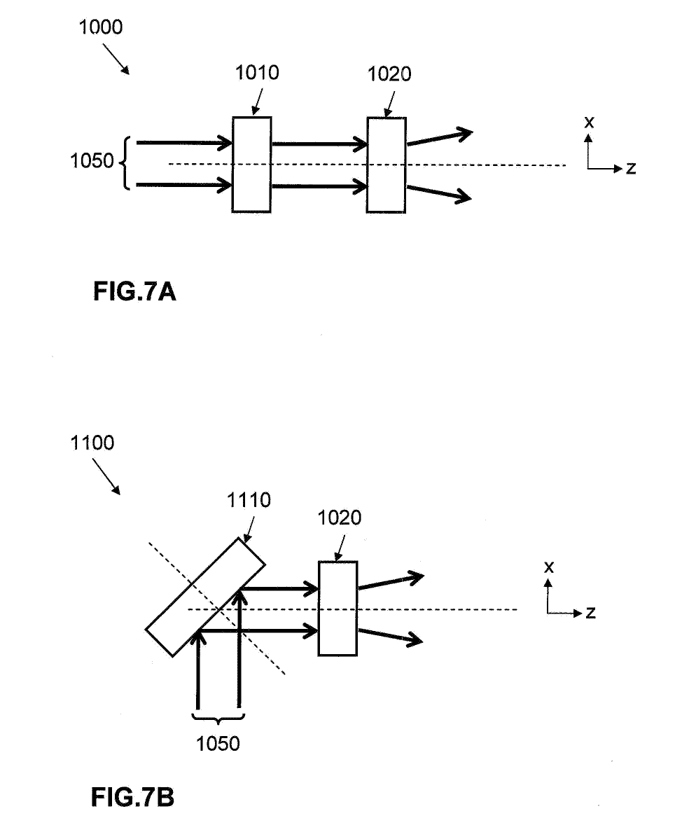

FIG. 7A shows a speckle reduction system 1000 comprising a transmissive device 1010, which can be any of the devices 200, 300, 600, 750, 760, 800, and 900 of FIGS. 2, 5, and 6, and an external transmissive diffuser 1020. A laser beam 1050 passes through device 1010 and then passes through the external diffuser 1020. The external diffuser 1020 can be reflective or transmissive. The external diffuser 1020 enhances the speckle reduction by providing additional temporal and spatial averaging of the speckle pattern.

FIG. 7B shows a speckle reduction system 1100 comprising a reflective device 1110, which can be any of the devices 400 and 500 of FIGS. 3 and 4, and an external transmissive diffuser 1020. A laser beam 1050 is reflected off of the surface of device 1110 and then passes through the external diffuser 1020. The external diffuser 1020 can be reflective or transmissive. The operation of the external diffuser 1020 is discussed in connection with the above speckle reduction system 1000 of FIG. 7A.

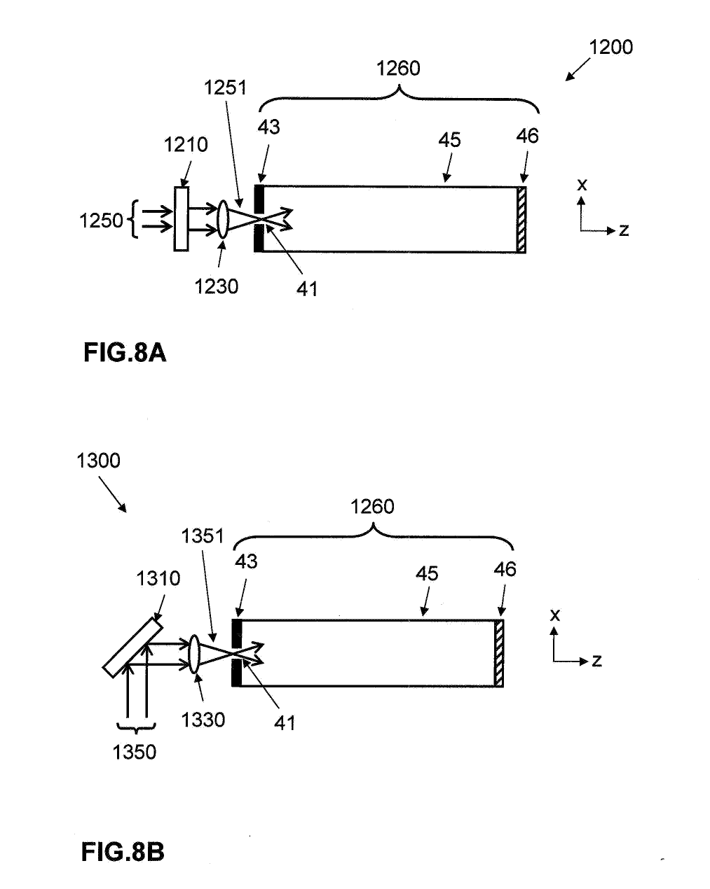

FIG. 8A shows a speckle reduction system 1200 comprising a transmissive device 1210, which can be any of the devices 200, 300, 600, 750, 760, 800, 900 and 1000 of FIGS. 2, 5, 6 and 7A, an optional lens 1230, and an integrator 1260 comprising a light guide 45, a highly reflective mirror 43 having a clear aperture 41 at the input face of the light guide 45 and a partially reflective mirror 46 at the exit face of the light guide 45. A laser beam 1250 passes through device 1210, gets focused by focusing lens 1230 into the light guide 45 through a clear aperture 41 in the highly reflective mirror 43. Successive beamlets exit the light guide 45 through the partially reflective mirror 46 to provide output light with a selected distribution.

FIG. 8B shows a speckle reduction system 1300 comprising a reflective device 1310, which can be any of the devices 400, 500 and 1100 of FIGS. 3, 4 and 7B, an optional lens 1330, and an integrator 1260. Components of integrator 1260 are described above in connection with FIG. 8A. For more speckle reduction, the length of the light guide 45 is preferably equal to an integer multiples of half the coherence length of the light beam 1251 entering the light guide 45. In some cases and when speckle reduction is effective using a device 200, 300, 400, 500, 600, 750, 760, 800, 900, 1000 and 1100, integrator 1260 operates as a mere integrator to provide a selected distribution of light at its exit aperture and its length does not have to be equal to an integer multiple of half the coherence length of the received light beam 1251 and 1351. The operation of speckle reduction system 1300 is briefly described as follows. A laser beam 1350 is reflected off of the surface of device 1310, gets focused by focusing lens 1330 into integrator 1260 through a clear aperture 41 in the highly reflective mirror 43. Successive beamlets exit the light guide 45 through the partially reflective mirror 46 to provide output laser light with reduced speckle and selected distribution. More detailed discussion of the operation of the integrator 1260 and its alternative implementations can be found in U.S. Patent Application Publication 2006/0012842 A1 to Abu-Ageel, which is hereby incorporated by reference in its entirety. In general, integrator 1260 can be replaced by any of the speckle reduction and/or integration systems described in U.S. Patent Application Publication No. 2006/0012842 A1.

Lens 1230 and 1330 can be a group of more than one lens and each lens can be a diverging, a focusing, a spherical, an aspherical, a plano-concave lens, a plano-convex lens, plano-concave micro-lens array, a plano-convex micro-lens array, holographic diffuser, non-holographic diffuser, or any other type.

A Fabrication process of devices 500 and 600 is discussed in U.S. Pat. Nos. 6,757,092 and 6,888,662 to Abu-Ageel, each of which is hereby incorporated by reference in its entirety.

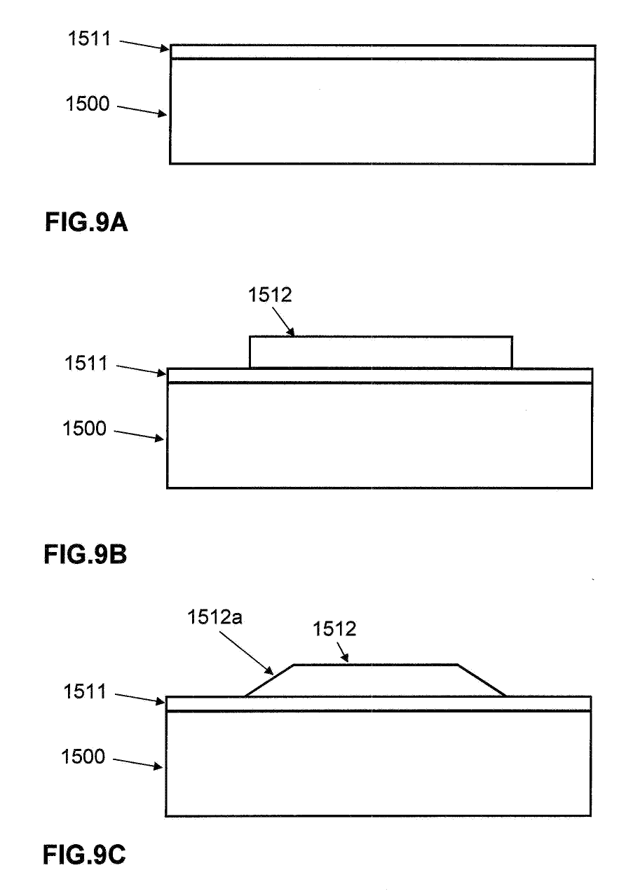

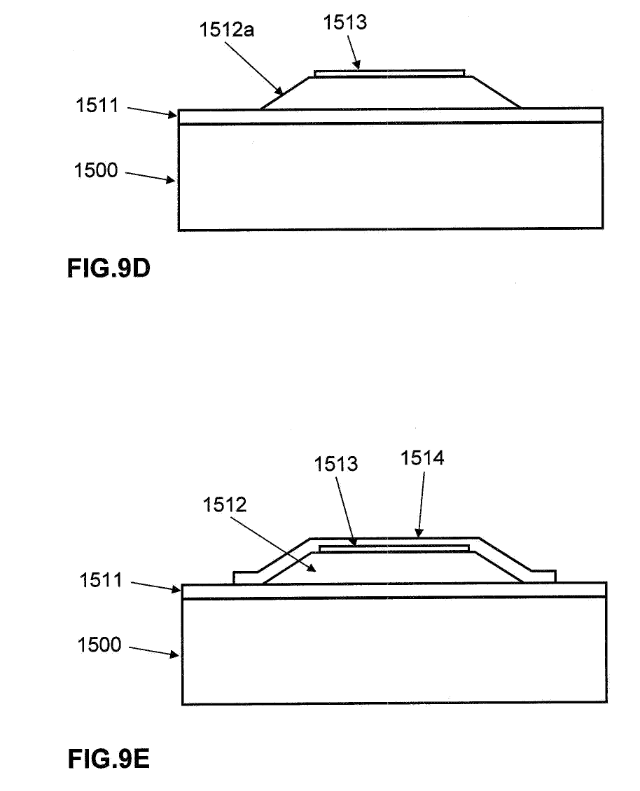

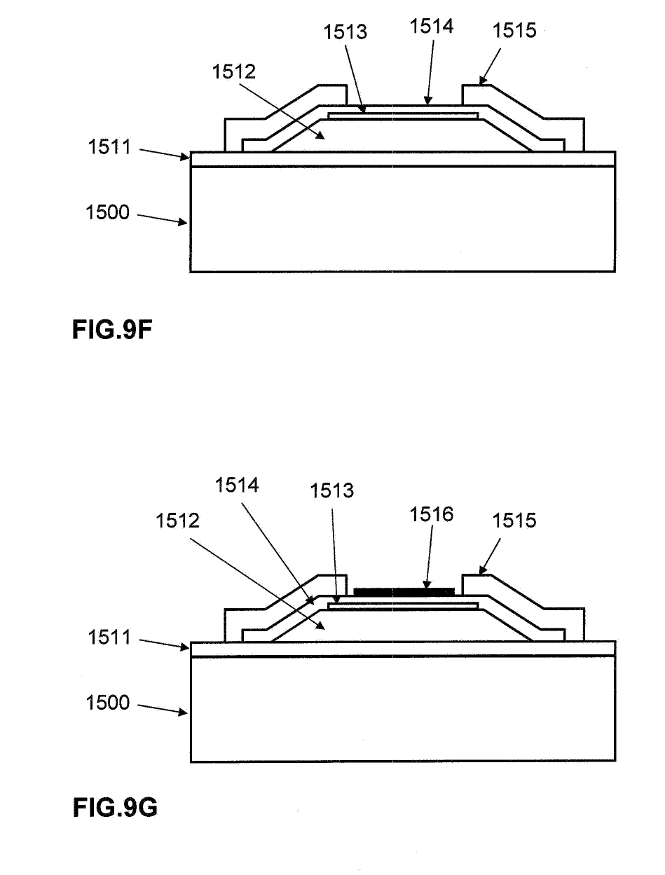

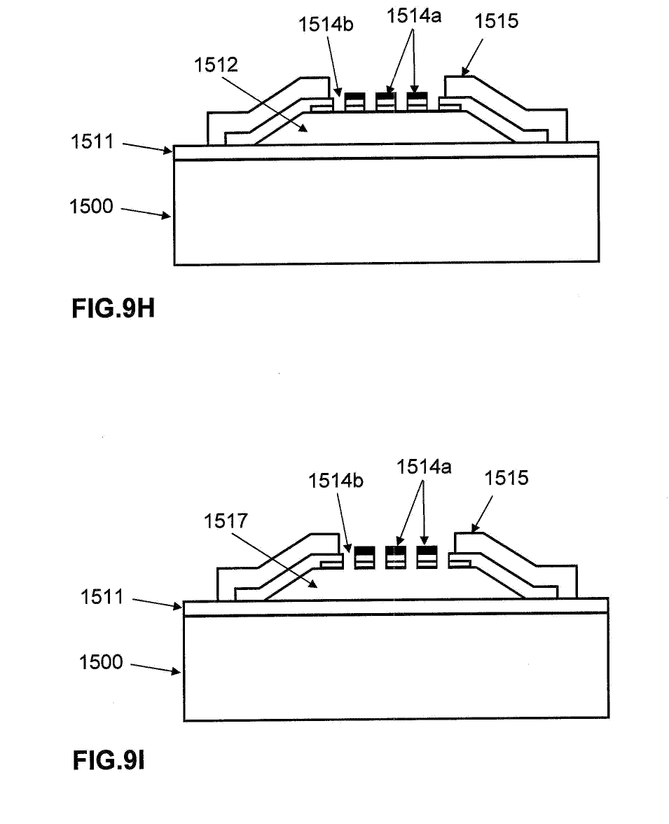

A fabrication process of devices 200, 300, and 400 is discussed below. First, starting with a substrate 1500 (FIG. 9A), a bottom electrode 1511 is deposited on the top surface of the substrate 1500. For transmissive devices 200 and 300, substrate 1500 is preferably a transparent substrate or an opaque substrate having a cavity to allow light transmission without substantial attenuation. For reflective devices 400, substrate 1500 can be transparent or opaque. For visible light, transparent substrates include glass, quartz, fused silica and opaque substrates include Si, SiC, and GaAs. The bottom electrode can be patterned according to any selected pattern.

As shown in FIG. 9B, a sacrificial layer 1512 is then deposited on top of bottom electrode 1511. Layer 1512 can be made of polyimide, oxide, or any other suitable material.

As shown in FIG. 9C, sacrificial structure 1512 is then patterned to produce a selected shape such as a square, circular or any other shape with tapered sidewalls 1512a.

A top electrode 1513 is then deposited on top of the sacrificial layer 1512 (FIG. 9D) and part of its sidewalls 1512a (not shown in FIG. 9D) and patterned according to a selected shape.

As shown in FIG. 9E, a thin layer (or thin membrane) 1514 is then deposited on top of the top electrode 1513, part of sacrificial layer 1512, tapered sidewalls 1512a of sacrificial layer 1512, and part of bottom electrode 1511. For transmissive devices 200 and 300, thin membrane 1514 is preferably a transparent layer. For reflective device 400 thin membrane 1514 can be transparent or opaque. Examples of thin membrane 1514 materials include silicon nitride, poly-silicon, and metal films.

As shown in FIG. 9F, a support layer 1515 is then deposited and patterned so that it covers the tapered sidewalls 1512a and extends a little further on both ends of the sidewalls taper. The support layer 1515 material can be silicon nitride, metal or another suitable material. The function of the support layer 1515 is to hold firmly the thin membrane 1514 above the bottom electrode 1511 after the removal of sacrificial layer 1512.

In case of reflective devices 400, a mirror 1516 is then deposited on top of the thin membrane 1514 as shown in FIG. 9G. Mirror 1516 can be made of a highly reflective metal layer (e.g. aluminum, gold, and silver), a dielectric mirror comprising alternating layers of low-index and high-index dielectric layers (e.g. silicon oxide, silicon nitride, and titanium oxide) with a thickness for each layer equal to quarter the wavelength of the light beam, or a combination of both types of mirrors. For transmissive devices 200 and 300, this step is skipped. Alternatively, the top electrode 1513 can be made of a highly reflective metal such as aluminum, gold, or silver. To enhance the reflectivity of such a metal forming top electrode 1513, a dielectric mirror can be deposited on top of it prior to the deposition of the thin membrane 1514.

As shown in FIG. 9H, the thin membrane 1514 is then patterned forming multiple beams 1514a (fixed at both ends to the support layer 1515 or cantilever beams fixed at one end to the support layer 1515) separated by areas 1514b free of thin membrane 1514, mirror 1516 and top electrode 1513 layers. The spacing 1514b between neighboring beams is later used to give access to etchants that remove the sacrificial layer 1512. If the thin membrane 1514 is not divided into multiple beams, small openings with diameters of few to several microns will be made in the thin membrane 1514 and top electrode 1513 layers to provide access to etchants that can selectively remove the underlying sacrificial layer 1512. Small openings can have shapes such circular, square, rectangular with sizes of few to tens of microns. The number, distribution and size of these openings can be used to enhance the spatial and temporal averaging of the speckle pattern without weakening structure of the thin membrane 1514 while providing enough access for the etchants to substantially remove the sacrificial layer 1512.

As shown in FIG. 9I, sacrificial layer 1512 is then selectively removed using a suitable dry or wet etch process to release the thin membrane 1514 and form an air gap 1517. For examples, oxygen plasma can be used to remove a sacrificial layer 1512 comprising polyimide where etchant species get access to the polyimide material through openings 1514b. It is preferable to use etch processes such as dry etch processes that do not cause the thin membrane 1514 to permanently stick to the bottom electrode after the removal of the sacrificial layer 1512.

Bottom electrode 1511, top electrode 1513, sacrificial 1512, support 1515, mirror 1516 and thin membrane 1514 layers can be patterned and deposited using semiconductor fabrication techniques such as lithography, sputtering, evaporation and chemical vapor deposition (CVD) and plasma assisted CVD. The electrically conductive bottom 1511 and top 1513 electrodes can be made of a transparent material such as tin indium oxide (TIN), very thin metal films, or patterned opaque films that allow light to pass through them without substantial attenuation.

Other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined with reference to the appended claims along with their full scope of equivalents.

What is claimed is:

1. A system for reducing laser speckle, comprising:
a deformable structure configured to interact with a laser beam; and
at least one electrode configured to apply an electric potential to the deformable structure so that the deformable structure causes a phase change or spatial movement of the laser beam.

2. The system of claim 1, wherein the deformable structure includes an array of transmissive beams configured to pass the laser beam.

3. The system of claim 2, wherein the transmissive beams are formed over a transmissive substrate configured to pass the laser beam.

4. The system of claim 3, further comprising a first transparent electrode on the transmissive substrate and a second transparent electrode on at least one of the transmissive beams.

5. The system of claim 2, wherein the beams are configured to actuated separately from each other.

6. The system of claim 2, wherein the beams are cantilever beams.

7. The system of claim 1, wherein the deformable structure includes an array of beams, each beam having a reflective surface configured to reflect the laser beam.

8. The system of claim 7, further comprising a substrate upon which the array of beams is mounted.

9. The system of claim 8, further comprising a first electrode on the substrate and a plurality of second electrodes, each of the second electrodes located on a corresponding one of the beams.

10. The system of claim 1, wherein the deformable structure includes a variable focus lens with a deformable surface.

11. The system of claim 10, further comprising a diffusive layer formed on the variable focus lens.

12. The system of claim 1, wherein the deformable structure includes a deformable surface having non-regular shape.

13. The system of claim 1, wherein the deformable structure includes a cell comprising:
an upper transparent plate;
a lower transparent plate having a recess;
a plurality of side walls between the upper and lower transparent plates forming an enclosure;
one or more first electrodes located in the recess;
an electrically insulating, transparent liquid located in the recess;
an electrically conductive transparent liquid located in the enclosure forming an interface with the electrically insulating liquid;
a second electrode located in the enclosure;
wherein applying a voltage between the first and second electrode causes the interface to change shape.

14. The system of claim 1, further comprising a diffuser configured to receive laser light output from the deformable structure.

15. The system of claim 1, further comprising an integrator configured to receive laser light output from the deformable structure.

16. The system of claim 15, wherein the integrator includes a light guide, a mirror having a transparent aperture formed therein at an input face of the light guide and partially reflective mirror at an exit face of the light guide.

17. The system of claim 16, wherein the length of the light guide is an integer multiple of one-half the coherence length of the laser beam entering the light guide.

18. A method for reducing laser speckle, comprising:
applying a laser beam to a deformable structure configured to interact with the laser beam; and
applying an electric potential to at least one electrode operatively coupled to the deformable structure so that the deformable structure causes a phase change or spatial movement of the laser beam.

19. The method of claim 18, wherein the deformable structure includes an array of deformable beams.

20. The method of claim 18, further comprising:
passing laser light from the deformable structure to an integrator.
